(19) United States
(12) Patent Application Publication
(10) Pub. No.: US 2004/0165299 A1
(43) Pub. Date: Aug. 26, 2004

(54) POWER CONSUMPTION DISTRIBUTION STRUCTURE AND METHOD FOR INTERNAL DEVICE OF SCANNER USING BUS SOURCE

(76) Inventor: SHIH-WEN KUO, TAINAN (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,869

(22) Filed: Feb. 26, 2003

(51) Int. Cl. G02B 1/00

(52) U.S. Cl. 359/896; 359/196

(57) ABSTRACT

Power consumption distribution structure and method for internal devices of a scanner using a bus source. The power consumption distribution structure has a bus current source, an applying power control device, switches and internanner. The power consumption distribution structure using a bus source avoids the transient surge caused by simultaneously switching on the devices by controlling the on/off operation of the internal devices of the scanner via the applying power control device. Only the required internal device is switched on, and the power supply is alternately provided to the devices consuming high power. Therefore, multiple application of the limited power provided by the computer host can be avoided.

### BACKGROUND OF INVENTION

1. Field of the Invention

The invention relates in general to device power consumption distribution structure and method, and more particular, to power consumption distribution structure and method of internal devices of a scanner using bus source.

2. Related Art of the Invention

The continuous progress in electronic technology has driven consumer electronic products to be developed with more powerful functions and faster operation speed. Products such as the scanner are designed according to the trends of being light, thin, short and small. To comply with the demands of more powerful functions and faster operation speed, more powerful devices have to be incorporated. As a result, more power is consumed. How to efficiently use the limited power supplied by the computer host and still achieve the ultimate function of the scanner have to be resolved.

FIG. 1 shows an internal structure of a conventional scanner using a bus source. The internal structure has a bus source 214, a control unit 202, a memory 204, a photodetector 206, an analog front end 208, a light source 210, and a step motor 212. The bus source 214 is connected to the computer host 10, via which the computer host 10 provides power to the scanner 20. The control unit 202 is coupled to the bus source 214 to set up the scanner 20. The memory 204 is coupled to the bus source 214 to provide the data access of the scanner 20. The photodetector 206 is coupled to the bus source 214 for receiving the reflected light by scanning a document, and converting the reflected light into data signals with various intensities to be output. The analog front end 208 is coupled to the bus source 214 to reset and output the data signals transmitted from the photodetector 206. The light source 210 is coupled to the bus source to emit a light for scanning the document. The step motor 212 is coupled to the bus source 214 to control the scanning speed of the photodetector 206.

When the conventional scanner 20 is switched on, the computer host 10 supplies power to the scanner 20 via the bus source 214 to activate the internal devices thereof. The internal devices are activated simultaneously; and consequently, a large transient surge is generated. Meanwhile, the load device consuming high power in the scanner 20 causes multiple applications of the limited power supplied by the computer host 10.

According to the above, the internal device structure of the conventional scanner using the bus source has the following drawbacks.

(1) While switching on the scanner, the internal devices of the scanner are activated simultaneously to generate extremely large transient surge.

(2) While switching on the scanner 20, the load devices consuming high power among the internal devices cause multiple application of the limited power supplied by the computer host 10.

(3) The internal devices of the scanner 20 can only be activated or inactivated simultaneously.

### SUMMARY OF INVENTION

The present invention provides a power consumption distribution structure of internal devices of a scanner using a bus source. The power consumption distribution structure uses an applying power control device to control the activation of the internal devices, such that the internal devices are prevented from being activated simultaneously; and consequently, the transient surface caused thereby is prevented.

The present invention further comprises a power consumption distribution method of internal devices of a scanner using a bus source. Only a specific internal device is activated as required, such that the power supply can be provided to the internal devices consuming relatively high power alternately. As a result, the multiple application of the limited power supply of the computer host is avoided.

The power consumption distribution structure of internal devices of a scanner using a bus source includes a bus source, a control unit, a memory, a photodetector, an analog front end, a light source, a step motor, an applying power control device.

The above bus source is coupled to the computer host, allowing the computer host to supply power to the scanner. The control unit is coupled to the bus source to set up the scanner and to generate control signals. The memory provides data access of the scanner. The photodetector receives the reflected light obtained by scanning a document, and converts the reflected light into data signals with various intensities to be output. The analog front end resets and outputs the data signal from the photodetector. The light source emits a light for scanning the document. The step motor controls the scanning speed of the photodetector. The applying power control device receives the control signals to control whether the bus source is supplied to the internal devices of the scanner.

According to an embodiment of the present invention, the applying power control device includes a switch, and first, second, third and fourth electric gates. The switch alternately supplies power to the light source and the step motor. The first electric gate is coupled to the bus source and the memory to supply power to the memory. The second electric gate is coupled between the bus source and the photodetector for supplying power thereto. The third electric gate is coupled between the bus source and the analog front end to provide power to the analog front end. The fourth electric gate is coupled between the bus source and the switch to provide power to the switch.

The applying power control device receives the control signals transmitted from the control unit via control signal lines to control the on/off status of the electric gates. Only when required, the internal devices are switched on via the electric gates. Therefore, the internal devices of the scanner are prevented from being activated at the same time. Thus, the transient surge caused thereby is avoided.

The present invention further comprises a power consumption distribution method for internal devices of a scanner using a bus source. The method comprises the following steps. When the scanner is switched on, the bus source is only supplied to the control unit. After setting up the control unit, the power is supplied to the memory. Before scanning the document, the photodetector and the analog front end are activated. When the scanner is scanning the document, the power is alternately supplied to the light source and the step motor. After scanning, the power supplied to the power source is turned off.

In the above method, only the required devices are activated, and the load devices consuming relatively high power are alternately supplied with power, so that the multiple application of the power is avoided.

### BRIEF DESCRIPTION OF DRAWINGS

These, as well as other features of the present invention, will become more apparent upon reference to the drawings wherein:

FIG. 1 shows the internal devices of a conventional scanner using a bus source;

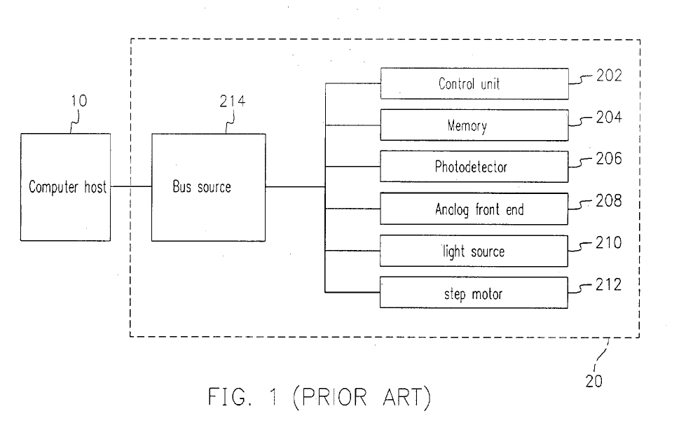

FIG. 2 shows a power consumption distribution structure for internal devices of a scanner using a bus source according to the present invention; and

FIG. 3 shows a process flow of a power consumption distribution method for internal devices of a scanner using a bus source according to the present invention.

### DETAILED DESCRIPTION

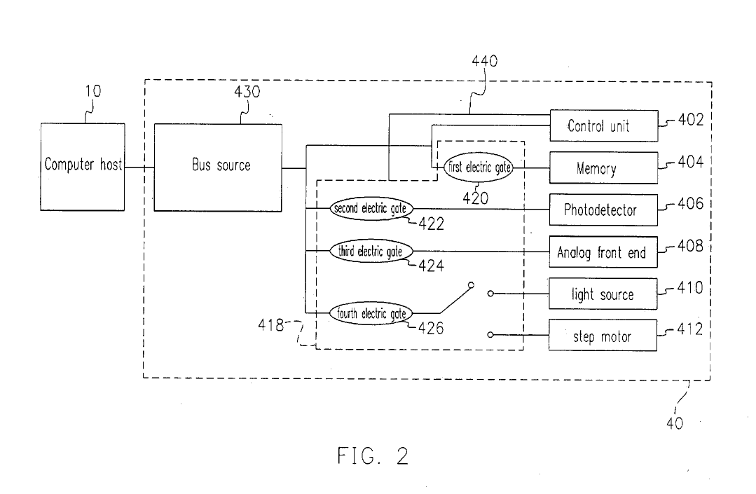

FIG. 2 shows a power consumption distribution structure for internal devices of a scanner using a bus source. The power consumption distribution structure comprises a bus source 430, a control unit 402, a memory 404, a photodetector 406, an analog front end 408, a light source 410, and a step motor 412. The bus source 430 is coupled to a computer host 10, such that the computer host 10 can provide power to the scanner 40. As known to one of ordinary skill in the art, the computer host 10 includes a personal computer or a laptop computer, but is not limited thereto. The bus source 430 includes the serial bus source, but is not limited thereto. The control unit 402 is coupled to the bus source 430 to accept power supplied thereby. The control unit 402 is used to set up the scanner 40 and to generate control signals. As known to one of ordinary skill in the art, the control unit 402 includes an application specific integrated circuit, but is not limited thereto.

The memory 404 provides data storage and access of the scanner. For example, the memory 404 includes a random access memory (RAM). The photodetector 406 receives the reflected light obtained by scanning a document, and converts the reflected light into data signals with various intensities to be output. The photodetector 402 includes a charge-coupled device, for example. The analog front end 408 resets and outputs the data signals from the photodetector 406. In addition, the step motor 412 controls the scanning speed of the photodetector 406. The light source 410 emits a light for scanning the document. The light source 410 includes a light emitting diode (LED), for example. The applying power control device 418 controls whether the bus source 430 is supplied to the memory 404, the photodetector 406, the analog front end 408, the light source 410, or the step motor 412.

According to an embodiment of the present invention, the applying power control device 418 comprises a switch 428, a first electric gate 420, a second electric gate 422, a third electric gate 424, and a fourth electric gate 426. The switch 428 alternately supplies power to the step motor 412 or the light source 410. The first electric gate 420 coupled between the bus source 430 and the memory 404 controls power supply to the memory 404. The second electric gate 422 is coupled between the bus source 430 and the photodetector 406 to control power supply to the photodetector 406. The third electric gate 424 is coupled between the bus source 430 and the analog front end 408 to control power supply to the analog front end 408. The fourth electric gate 426 is coupled between the bus source 430 and the switch 428 to control power supply to the switch 428.

The applying power control device 418 receives the control signals transmitted from the control unit 402 via control signal lines 440 to control the on/off state of the first to fourth electric gates 420 to 426. Via the electric gates 420 to 426, the bus source activates the internal devices of the scanner 40 sequentially to avoid multiple application of the power source, such that the transient surge caused by simultaneous activation of the internal devices is prevented.

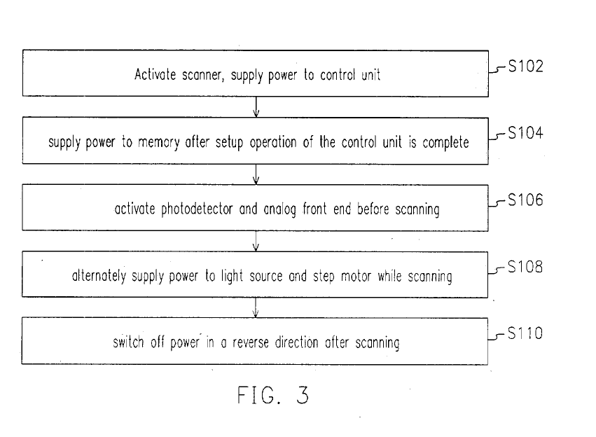

FIG. 3 shows a process flow of a power consumption distribution method for internal devices of a scanner using a bus soce. The method comprises the following steps.

In step s102, the bus source is only provided to the control unit when the scanner is activated. In step s104, the powsupplied to the memory after the control unit completes a set-up operation. In step s106, the photodetector and the analog font end are activated while preparing to scan a document. In step s108, the light source and the step motor are alternately supplied with power. In step S110, the power is switched off in reversed sequence after the document scanned.

Only the required internal devices are activated when the scanner is scanning a document, and the load device, such as the light source and the step motor, is alternately supplied with power to avoid the bus source providing an excessively large t the same time.

According to the above, the power consumption distribution structure and method provided by the present invention has the following advantages.

(1) Only the required internal device is activated via the corresponding electric ga that the simultaneous activation is avoided, and the transient surge is prevented from being generated.

(2) The activation of the intvices of the scanner can be controlled independently via the corresponding electric gate.

(3) The load devices that consume relatively high power are alternately activated avoid multipleion of the power source.

Other embodiments of the invention will appear to those skilled in the art from considerationspecification and practice of the invention disclosed herein. It is that the specification and examples to be considered as exempl, with a true scope and spirit of the invention being indicated by the following claims.

1. A power consumption distribution structure for internal devices of a scanner using a bus source, suitable for use when power is supplied from a computer host to the scanner via the bus source, the power consumption distribution structure comprising:
a bus source, providing power from the computer host to the scanner;
a control unit, to set up the scanner and to generate control signals;
a photodetector, receiving a reflected light obtained from scanning a document, and converting the reflected light into data signals with various intensities to be output;
an analog front end, resetting the data signals output from the photodetector;
a light source, to emit a light for scanning the document;
a step motor, controlling a scanning speed of the photodetector; and
an applying power control device receiving the control signals to control whether the bus source is supplied to the memory, the photodetector, the analog front end, the light source, or the step motor.

2. The power consumption distribution structure according to claim 1, wherein the applying power control device comprises:
a switch, alternately supplying power to the step motor and the light source;
a first electric gate, coupled to the bus source and the memory for supplying power to the memory;
a second electric gate, coupled to the bus source and the photodetector for supplying power to the photodetector;
a third electric gate, coupled to the bus source and the analog front end for supplying power to the analog front end; and
a fourth electric gate, coupled to the bus source and the switch for supplying power to the switch.

3. The power consumption distribution structure according to claim 1, wherein the computer host includes either a personal computer or a laptop computer.

4. The power consumption distribution structure according to claim 1, wherein the bus source includes a serial bus source.

5. The power consumption distribution structure according to claim 1, wherein the control unit includes an application specific integrated circuit.

6. The power consumption distribution structure according to claim 1, wherein the memory includes a random access memory.

7. The power consumption distribution structure according to claim 1, wherein the photodetector comprises a charge-coupled device.

8. The power consumption distribution structure according to claim 1, wherein the light source includes a light emitting diode.

9. A power consumption distribution method for internal devices of a scanner using a power source to activate the scanner, the method comprising:
a. supplying power to only a control unit when the scanner is activated;
b. supplying power to a memory when the control unit completes setup operation;
c. activating a photodetector and an analog front end before scanning a document;
d. alternately supplying power to a plurality of high power consumption devices; and
e. switching off power in a reverse direction.

10. The method according to claim 9, wherein only the required internal device is activated.

11. The method according to claim 9, wherein the high power consumption devices include a step motor and a light source.
